(19) United States
(12) Patent Application Publication
(10) Pub. No.: US 2009/0099823 A1
(43) Pub. Date: Apr. 16, 2009

(54) System and Method for Implementing Environmentally-Sensitive Simulations on a Data Processing System

(76) Inventors: David S. Freeman, Austin, TX (US); Ori Pomerantz, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/872,769

(22) Filed: Oct. 16, 2007

(51) Int. Cl. G06G 7/48

(52) U.S. Cl. 703/6

(57) ABSTRACT

A system and method for implementing environmentally-sensitive simulations on a data processing system. According to an embodiment of the present invention, a presentation manager provides a collection of presentation levels within a simulation, wherein each of the presentation levels is associated with a collection of ambient light levels. An environmental sensor detects an ambient light level associated with a user's location as the user is operating a system that displays the simulation. The presentation manager selects at least one presentation level among the collection of presentation levels based on the ambient light level associated with the user's location. The simulation application displays the selected at least one presentation level within the simulation to the user.

### BACKGROUND OF THE INVENTION

1. Technical Field

The present invention relates in general to the field of data processing system and in particular, the field of processing data within data processing systems. Still more specifically, the present invention relates to the field of entertainment and simulation applications utilizing data processing systems.

2. Description of the Related Art

With the rapid advance of computer technology, some of the most lucrative and popular applications include video games and simulations. With each successive generation of computer hardware, video game and simulation developers seek to generate a progressively more immersive gaming and/or simulation experience for the user.

### SUMMARY OF THE INVENTION

The present invention includes a system and method for implementing environmentally-sensitive simulations on a data processing system. According to an embodiment of the present invention, a presentation manager provides a collection of presentation levels within a simulation, wherein each of the presentation levels is associated with a collection of ambient light levels. An environmental sensor detects an ambient light level associated with a user's location as the user is operating a system that displays the simulation. The presentation manager selects at least one presentation level among the collection of presentation levels based on the ambient light level associated with the user's location. The simulation application displays the selected at least one presentation level within the simulation to the user.

The above, as well as additional objectives, features, and advantages of the present invention, will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a pictorial representation of an exemplary network in which an embodiment of the present invention may be implemented;

FIG. 2 depicts an exemplary data processing system in which an embodiment of the present invention may be implemented; and

FIG. 3 is a high-level logical flowchart diagram illustrating an exemplary method for implementing environmentally-sensitive simulations on a data processing system according to an embodiment of the present invention.

### DETAILED DESCRIPTION OF AN EMBODIMENT

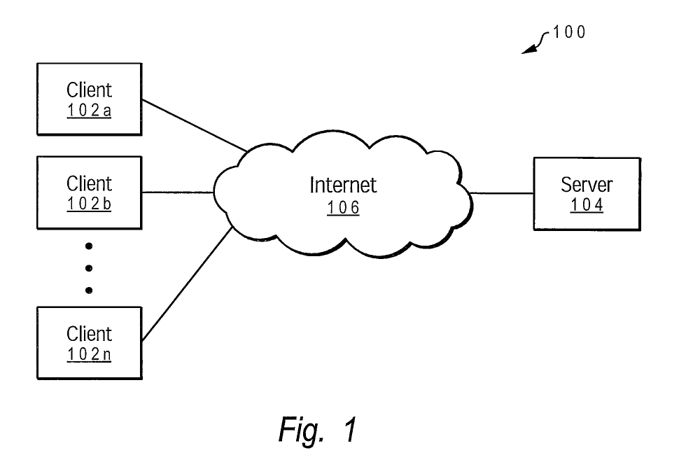

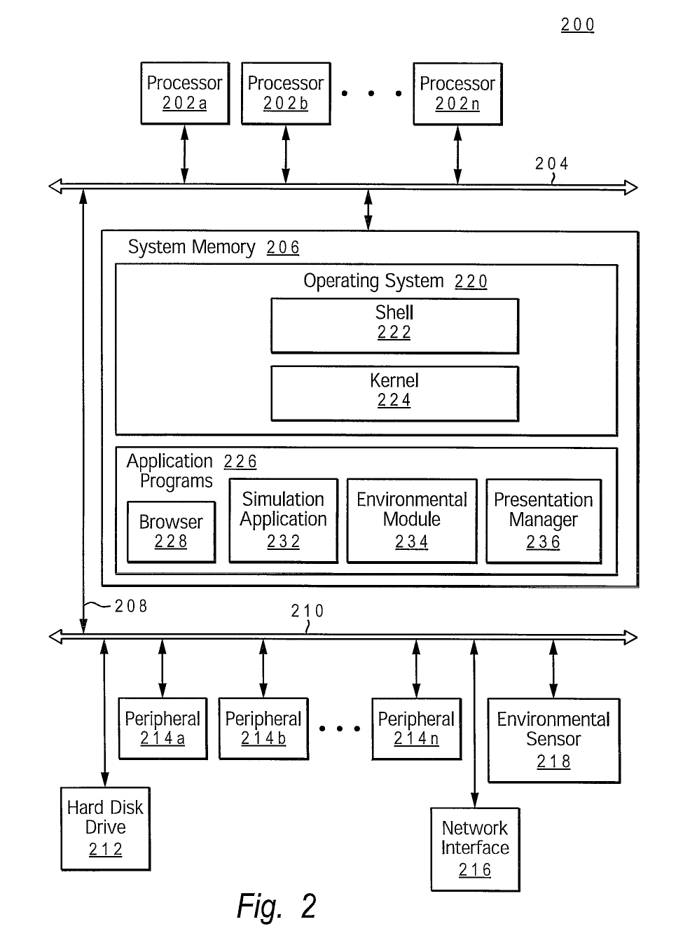

Referring now to the figures, and in particular, referring to FIG. 1, there is illustrated a block diagram depicting an exemplary network 100 in which an embodiment of the present invention may be implemented. As depicted, network 100 includes a collection of clients 102a-102n, Internet 106, and server 104. Clients 102a-102n are coupled to server 106 via Internet 104. While Internet 104 is utilized to couple clients 102a-102n to server 106, those with skill in the art will appreciate that a local-area network (LAN) or wide-area network (WAN) utilizing Ethernet, IEEE 802.11x, or any other communications protocol may be utilized. Clients 102a-102n and server 106 are discussed herein in more detail in conjunction with FIG. 2.

According to an embodiment of the present invention, clients 102a-102n may be implemented as client computer systems that connect to server 104 to launch a simulation and/or video game. The simulation and/or video game may be limited to single-user game play or include multiplayer game play options. Also, according to an embodiment of the present invention, clients 102a-102n may utilize a browser stored in system memory to send and receive information to and from server 104. The information may include e-mails, web pages, and the like. Those with skill in the art will appreciate that exemplary network 100 may include other components such as routers, firewalls, etc. that are not germane to the discussion of the present network and will not be discussed further herein.

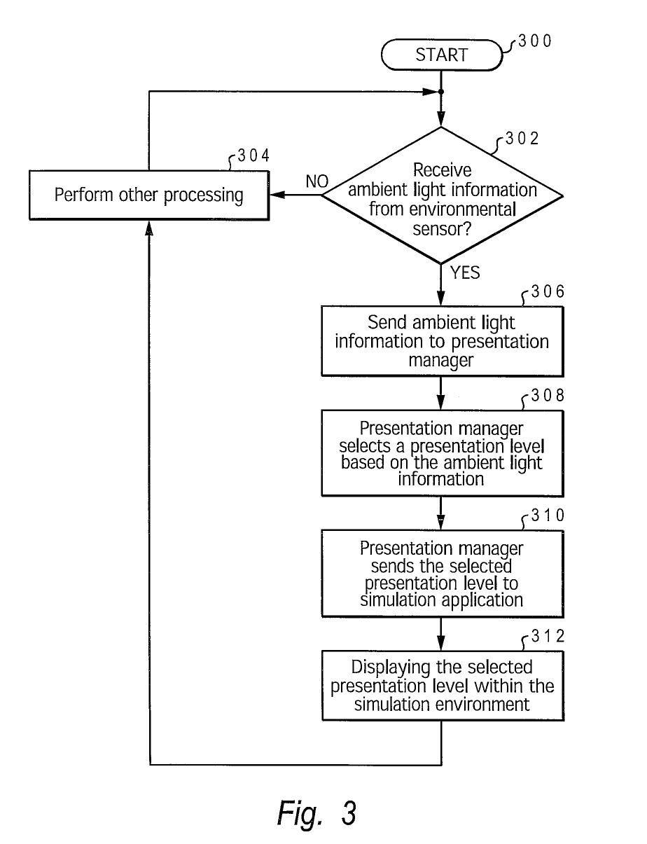

FIG. 2 is a block diagram depicting an exemplary data processing system 200, which may be utilized to implement clients 102a-102n and server 104 as shown in FIG. 1. Those with skill in the art will appreciate that data processing system 200 may be implemented as, but not limited to, a computer workstation, game console, portable gaming system, portable phone, etc. As illustrated, exemplary data processing system 200 includes a collection of processors 202a-202n that is coupled to a system memory 206 via a system bus 204. System memory 206 may be implemented by dynamic random access memory (DRAM) modules or any other type of random access memory (RAM) module. Mezzanine bus 208 couples system bus 204 to peripheral bus 210. Coupled to peripheral bus 210 is a hard disk drive 212 for mass storage and a collection of peripherals 214a-214n, which may include, but are not limited to, optical drives, other hard disk drives, printers, and input devices, and the like. Network interface 216 enables data processing system 200 to communicate on a network, such as, but not limited to Internet 106. Environmental sensor 218, discussed herein in more detail in conjunction with FIG. 3, measures various aspects of the user's environment including, but not limited to ambient light, sound, and temperature, and relays the information to environmental module 234. Environmental module 234 sends the information measured by environmental sensor 218 to simulation application 232, which in turn, affects the simulation environment, thus providing a more realistic simulation experience for the user. According to an embodiment of the present invention, in the case of an ambient light dependent simulation and/or video game, environmental sensor 218 may be implemented as a light-sensitive sensor.

Included in system memory 206 is operating system 220, which further includes a shell 222 (as it is called in the UNIX® operating system. UNIX® is a registered trademark of The Open Group in the United States and other countries), for providing transparent user access to resources such as application programs 226. Generally, shell 222, also called a command processor in Microsoft® Windows® operating system, is the highest level of the operating system software hierarchy and serves as a command interpreter. Microsoft® and Windows® are trademarks of Microsoft Corporation in the United States, other countries, or both. Shell 222 provides a system prompt, interprets commands entered by keyboard, mouse, or other input media, and sends the interpreted command(s) to the appropriate lower levels of the operating system (e.g., kernel 224) for processing. Note that while shell 222 is a text-based, line-oriented user interface, the present invention will support other user interface modes, such as graphical, voice, gestural, etc. equally well.

As illustrated, operating system 220 also includes kernel 224 which includes lower levels of functionality for operating system 220 and application programs 226, including memory management, process and task management, disk management, and mouse and keyboard management. Application programs 226 can include browser 228, utilized for access to Internet 106 (FIG. 1), word processors, spreadsheets, and other application programs. Also, as depicted, system memory 206 includes simulation application 232 and environmental module 234. As discussed herein in more detail, simulation application 232 may be implemented by any type of simulator (e.g., flight, driving, role-playing game, virtual reality, etc.) and/or video game.

One feature of simulators and/or video games is that simulator and/or video game developers attempt to provide as much of an immersive experience for the user as possible. Most developers have concentrated on providing increasingly realistic graphics and sounds in their simulations and/or video games.

According to an embodiment of the present invention, environmental module 234 retrieves data from environmental sensor 218. Environmental module 234 sends the information measured by environmental sensor 218 to presentation manager 236, which selects a presentation level based on the information received from environmental module 234. Presentation manager 236 sends the selected presentation level to simulation application 232, which in turn, displays the selected presentation level within the simulation environment, thus providing a more realistic simulation experience for the user.

FIG. 3 is a high-level logical flowchart illustrating an exemplary method for implementing environmentally-sensitive simulations on a data processing system according to an embodiment of the present invention. The process begins at step 300, and proceeds to step 302, which illustrates environmental module 234 determining if ambient light information has been received from environmental sensor 218. According to an embodiment of the present invention, the ambient light information is an ambient light of the area surrounding environmental sensor 218 such as the room in which the user is running the simulation and/or video game. If no ambient light information has been received, the process continues to step 304, which depicts data processing system 200 performing other processing. The process returns to step 302.

If ambient light information has been received from environmental sensor 218, the process continues to step 306, which illustrates environmental module 234 sending the ambient light information to presentation manager 236. The process proceeds to step 308, which depicts presentation manager 236 selecting a presentation level based on the received ambient light information.

The process continues to step 310, which depicts presentation manager 236 sending the selected presentation level to simulation application 232. The process proceeds to step 312, which depicts simulation application 232 displaying the simulation environment presented to the user based on the selected presentation level. The process proceeds to step 304, which illustrates data processing system 200 performing other processing. Then, the process returns to step 302.

According to an embodiment of the present invention, the collection of presentation levels include, but are not limited to, a well-lit and open field, a dark and foreboding forest, a hot sunny beach, a cold ice cave, or any other location that can be simulated in a simulation and/or video game. Presentation levels may also include how the playable character in the simulation and/or video is dressed (e.g., winter coat, shorts, ski jacket, etc.). The storyline of the simulation and/or video game may be changed depending on the selected presentation level. The adversaries faced by the player may be different, be dressed differently, and/or react differently based on the selected presentation level. Different light conditions can affect visibility, both for the player and/or the player's adversaries.

As previously discussed, there is a connection between the measured ambient light level and the collection of presentation levels in the simulation environment. For example, if the measured ambient light level from environmental sensor 218 is a bright, intense light level, presentation manager 236 may select a presentation level that includes a well-lit and open area. Conversely, if the measured ambient light level from environmental sensor 218 is a dark light level, presentation manager 236 may select a presentation level that includes a dark cave or forest. The playable character's dress, actions, adversaries faced, and storyline may change according to the selected presentation level. After presentation manager 236 selects the appropriate presentation level, simulation application 232 displays the selected presentation level in the simulation and/or video game to the user.

In another embodiment of the present invention, the ambient light information does not have to be provided by environmental sensor 218, but such ambient light information can be entered by a user or downloaded from another location on the Internet, such as a weather website.

As discussed, the present invention includes a system and method for implementing environmentally-sensitive simulations on a data processing system. According to an embodiment of the present invention, a presentation manager provides a collection of presentation levels within a simulation, wherein each of the presentation levels is associated with a collection of ambient light levels. An environmental sensor detects an ambient light level associated with a user's location as the user is operating a system that displays the simulation. The presentation manager selects at least one presentation level among the collection of presentation levels based on the ambient light level associated with the user's location. The simulation application displays the selected at least one presentation level within the simulation to the user.

It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to random access memory (RAM), and communication media, such as computer networks and telephone networks, including Ethernet, the Internet, wireless networks, and like networks. It should be understood, therefore, that such signal-bearing media, when carrying or encoding computer-readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made herein without departing from the spirit and scope of the invention.

What is claimed is:

1. A computer-implementable method for implementing environmentally-sensitive simulations on a data processing system, said computer-implementable method comprising:
providing a plurality of presentation levels within a simulation, wherein each one of said presentation levels associated with a plurality of ambient light levels;
providing an ambient light level associated with a user's location as said user is operating a system that displays said simulation;
selecting at least one presentation level among said plurality of presentation levels based on said ambient light level associated with said user's location; and
displaying said selected at least one presentation level within said simulation to said user.

2. The computer-implementable method according to claim 1, wherein said providing an ambient light level further comprises:
providing said ambient light level associated with said user's location via an environmental sensor coupled to said data processing system.

3. The computer-implementable method according to claim 1, wherein said providing an ambient light level further comprises:
providing said ambient light level associated with said player's location from an information depository via a network.

4. A system for implementing environmentally-sensitive simulations on a data processing system, said system comprising:
an interconnect coupled to said at least one processor; and
a computer-usable medium embodying computer program code, said computer-usable medium being coupled to said interconnect, said computer program code comprising instructions executable by said at least one processor and configured for:
providing a plurality of presentation levels within a simulation, wherein each one of said presentation levels associated with a plurality of ambient light levels;
providing an ambient light level associated with a user's location as said user is operating a system that displays said simulation;
selecting at least one presentation level among said plurality of presentation levels based on said ambient light level associated with said user's location; and
displaying said selected at least one presentation level within said simulation to said user.

5. The system according to claim 4, said instructions for providing an ambient light level further comprises:
providing said ambient light level associated with said user's location via an environmental sensor coupled to said data processing system.

6. The system according to claim 4, said instructions for providing an ambient light level further comprises:
providing said ambient light level associated with said player's location from an information depository via a network.
